(19) United States
(12) Patent Application Publication
(10) Pub. No.: US 2015/0140531 A1
(43) Pub. Date: May 21, 2015

(54) SMART EARLY LEARNING SYSTEM

(71) Applicant: InnoSchool Finland Oy, Espoo (FI)

(72) Inventor: Tuuli Tiitola-Meskanen, Espoo (FI)

(73) Assignee: InnoSchool Finland Oy, Espoo (FI)

(21) Appl. No.: 14/081,868

(22) Filed: Nov. 15, 2013

(51) Int. Cl. G09B 5/00

(52) U.S. Cl. CPC G09B 5/00
USPC 434/238; 434/236

(57) ABSTRACT

A method for developmental evaluation is provided. A user is presented with a menu of developmental activities. A user input selecting a developmental activity from the menu is received. A user performance of the selected developmental activity is recorded. Consequently, the user is awarded a point value to a user score in an activity topic and/or an activity dimension associated with the selected developmental activity. Subsequently, the user score in the activity topic and/or the activity dimension is compared with user scores in other activity topics and/or activity dimensions to determine whether the user scores are balanced. An output is used to influence the user to perform one or more developmental activities from activity topics and/or activity dimensions that contribute to balancing user scores across all activity topics and activity dimensions.

### TECHNICAL FIELD

The present disclosure relates generally to educational systems, and more specifically, to systems for developmental evaluation. Moreover, the present disclosure relates to methods for developmental evaluation. Furthermore, the present disclosure also relates to computer program products that include non-transitory (non-transient) computer-readable storage media storing computer-executable code for evaluating development.

### BACKGROUND

Recent breakthroughs in research emphasize a critical role of early education in empowering a potential of a future society. In his State of the Union address on Feb. 12, 2013, US President Barack Obama stated “Research has shown that the early years of a child's life—when the human brain is forming—represent a critically important window of opportunity to develop a child's full potential and shape key academic, and cognitive skills that determine a child's success in school and in life.”

In 2010, renowned education researcher, Knud Illeris, stated “While learning is a fundamental and primary function of human life, in our times the level of education and skills of nations, companies and individuals has become a crucial parameter of competition in the knowledge society and the globalized market.”

However, no contemporary early learning approach or mobile application offers an educational system recognizing multiple vital dimensions of early learning. As contemporary educational systems mainly focus on one isolated dimension of learning, usually stressing the cognitive dimension, they do not cover a full range of developmental needs of young children.

Therefore, there exists a need for a system for developmental evaluation that covers the full range of the developmental needs of young children.

### SUMMARY

The present disclosure seeks to provide a computer-implemented method for developmental evaluation.

The present disclosure also seeks to provide a system for developmental evaluation.

In one aspect, embodiments of the present disclosure provide a computer-implemented method for developmental evaluation. A user is presented with a menu of developmental activities. Each developmental activity is associated with at least one of a plurality of activity topics and/or at least one of a plurality of activity dimensions. A user input selecting a developmental activity from the menu is received. Subsequently, a user performance of the selected developmental activity is recorded. In accordance with the recorded user performance, the user is then awarded a point value to a user score in an activity topic and/or an activity dimension associated with the selected developmental activity.

Subsequently, the user score in the activity topic and/or the activity dimension is compared with user scores in other activity topics and/or activity dimensions to determine whether or not the user scores are balanced. If it is found that the user scores are not balanced, an output is used to influence the user to perform one or more developmental activities from activity topics and/or activity dimensions that contribute to balancing user scores across all activity topics and activity dimensions.

In another aspect, embodiments of the present disclosure provide a system for developmental evaluation.

In yet another aspect, embodiments of the present disclosure provide a computer program product that includes a non-transitory (non-transient) computer-readable storage medium storing computer-executable code for evaluating development. The code, when executed, is configured to implement the aforementioned method.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example network environment that is suitable for practicing embodiments of the present disclosure;

FIG. 2 is a schematic illustration of various components of a data processing unit, in accordance with an embodiment of the present disclosure;

FIG. 3 is a schematic illustration of an example chart of activity topics and activity dimensions, in accordance with an embodiment of the present disclosure;

FIG. 4 is a schematic illustration of how the example chart may be used to demonstrate a developmental-balance level, in accordance with an embodiment of the present disclosure;

FIG. 5 is a schematic illustration of an example developmental activity, in accordance with an embodiment of the present disclosure; and

FIGS. 6A and 6B collectively are an illustration of steps of a computer-implemented method for developmental evaluation, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

Embodiments of the present disclosure provide a computer-implemented method for developmental evaluation. A user is presented with a menu of developmental activities. Each developmental activity is associated with at least one of a plurality of activity topics and/or at least one of a plurality of activity dimensions. A user input selecting a developmental activity from the menu is received. Subsequently, a user performance of the selected developmental activity is recorded. In accordance with the recorded user performance, the user is then awarded a point value to a user score in an activity topic and/or an activity dimension associated with the selected developmental activity.

Subsequently, the user score in the activity topic and/or the activity dimension is compared with user scores in other activity topics and/or activity dimensions to determine whether or not the user scores are balanced. If it is found that the user scores are not balanced, an output is used to influence the user to perform one or more developmental activities from activity topics and/or activity dimensions that contribute to balancing user scores across all activity topics and activity dimensions.

Additionally, the user may be presented with an output demonstrating a developmental-balance level. For this purpose, a mapping of a closed developmental-balance curve may be rendered within a spatial arrangement of activity topics and activity dimensions.

When the developmental-balance level is low, a distance of points on the closed developmental-balance curve from a given point bounded by the closed developmental-balance curve is greatly varied. This encourages the user to perform developmental activities from activity topics and/or activity dimensions in which he/she is lagging.

Moreover, the closed developmental-balance curve is expanded in a space of the mapping when a pre-defined user score for advancing within an activity topic or an activity dimension associated with that space has been reached.

Furthermore, a reporting reliability factor of the user is established by comparing a manually-reported user performance of the selected developmental activity with an automatically-reported user performance of the selected developmental activity. The reporting reliability factor of the user is then used to modify future manually-reported user performances.

Embodiments of the present disclosure substantially eliminate, or at least partially address, problems in the prior art, enabling and, in some cases, influencing users to perform developmental activities from activity topics and/or activity dimensions in which they are lagging. Thus, user scores may be balanced across all activity topics and activity dimensions; to facilitate a balanced overall development of the users.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

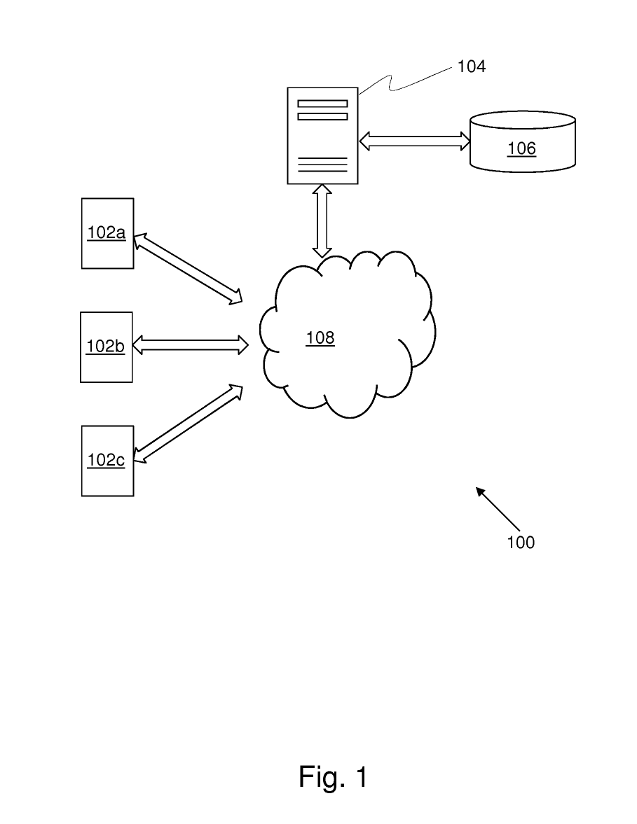

Referring now to the drawings, particularly by their reference numbers, FIG. 1 is a schematic illustration of an example network environment 100 that is suitable for practicing embodiments of the present disclosure. The network environment 100 includes one or more data processing units, depicted as a data processing unit 102a, a data processing unit 102b and a data processing unit 102c in FIG. 1 (hereinafter collectively referred to as data processing units 102). The network environment 100 also includes a server 104, a database 106 associated with the server 104, and a communication network 108.

The network environment 100 may be implemented in various ways, depending on various possible scenarios. In one example scenario, the network environment 100 may be implemented by way of a spatially collocated arrangement of the server 104 and the database 106. In another example scenario, the network environment 100 may be implemented by way of a spatially distributed arrangement of the server 104 and the database 106 coupled mutually in communication via the communication network 108. In yet another example scenario, the server 104 and the database 106 may be implemented via cloud computing services.

The data processing units 102 are coupled in communication with the server 104 via the communication network 108. The communication network 108 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of the data processing units 102 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

The network environment 100 is suitable for implementing various systems for developmental evaluation. In order to implement a system for developmental evaluation, the server 104 provides a developmental-evaluation service (not shown in FIG. 1) to the data processing units 102, while the database 106 stores data related to the developmental-evaluation service. The developmental-evaluation service may, for example, include at least one of: an educational service, a learning service, a gaming service, and/or a simulation service. Accordingly, the system can be implemented by way of at least one of: a physical learning environment, an online gaming system, and/or a software product.

Optionally, the data processing units 102 may access the server 104 to download one or more software products associated with the developmental-evaluation service. In one embodiment, the system is arranged in a manner that its functionality is implemented partly in the data processing units 102 and partly in the server 104.

In another embodiment, the system is arranged in a manner that its functionality is implemented substantially in the data processing units 102 by way of the downloaded software products. In such a situation, the data processing units 102 may be coupled to the server 104 periodically or randomly from time to time, for example, to receive updates from the server 104 and/or to upload status to the server 104.

In yet another embodiment, the system is arranged in a manner that its functionality is implemented substantially in the server 104.

Users associated with the data processing units 102 use the developmental-evaluation service. Accordingly, some of the data processing units 102 may be used, operated, or carried by students, while some of the data processing units 102 may be used, operated, or carried by teachers or other persons responsible for keeping a track of progress shown by at least one of these students. In some examples, some of the data processing units 102 may be used, operated, or carried by parents or guardians of the students. The system encourages the parents to participate in certain developmental activities performed by the students and/or to monitor developmental activities that cannot be digitalized.

For illustration purposes, let us consider that a user A is associated with the data processing unit 102a, a user B is associated with the data processing unit 102b, and a user C is associated with the data processing unit 102c. Let us also consider, in an example scenario, that the user A is a student. The student is presented with a menu of developmental activities, for example, on a display screen of the data processing unit 102a. Each developmental activity is associated with at least one of a plurality of activity topics and/or at least one of a plurality of activity dimensions.

The student selects a developmental activity from the menu, and performs the selected developmental activity. The selected developmental activity may be a physical activity, a mental activity or a combination thereof. Additionally, the selected developmental activity may be performed with the data processing unit 102a and/or other accessories, such as a pen and a paper.

In an embodiment of the present disclosure, the data processing unit 102a and/or the server 104 substantially continuously record and update changes in the status of the selected developmental activity in the database 106, while the selected developmental activity is being performed with the data processing unit 102a. The data processing unit 102a is optionally configured to resume the status of the selected developmental activity to its last updated status in the database 106, in case of interruptions in the operable state of the developmental-evaluation service.

Meanwhile, the developmental-evaluation service keeps a record of a user performance of the selected developmental activity. The user performance may be recorded and reported to the developmental-evaluation service automatically. Additionally or alternatively, the developmental-evaluation service may allow the student to record and report his/her performance manually. The developmental-evaluation service may then be operable to establish a reporting reliability factor of the student by comparing a manually-reported user performance of the selected developmental activity with an automatically-reported user performance of the selected developmental activity. The developmental-evaluation service then uses the reporting reliability factor to modify future manually-reported user performances.

Consequently, a point value is awarded to a user score in an activity topic and/or an activity dimension associated with the selected developmental activity, in accordance with the recorded user performance. The user score is then stored in the database 106.

Subsequently, the user score in the activity topic and/or the activity dimension is compared with user scores in other activity topics and/or activity dimensions to determine whether or not the user scores are balanced. If it is found that the user scores are not balanced, an output is presented on the display screen of the data processing unit 102a to influence the student to perform one or more developmental activities from activity topics and/or activity dimensions that contribute to balancing user scores across all activity topics and activity dimensions.

Additionally, the developmental-evaluation service may allow the students to form groups, for example, to perform certain developmental activities in their respective groups. Optionally, the developmental-evaluation service may allow the students to form social-network correlations between themselves and/or with their teachers.

Accordingly, the server 104 stores user-related information in the database 106. The user-related information of a particular student may, for example, include at least one of: a user account of that particular student, individual user scores of that particular student in various developmental activities, accumulated user scores of that particular student in various activity topics and/or activity dimensions, a reporting reliability factor of that particular student, a developmental-balance level of that particular student, and/or associated time-stamps.

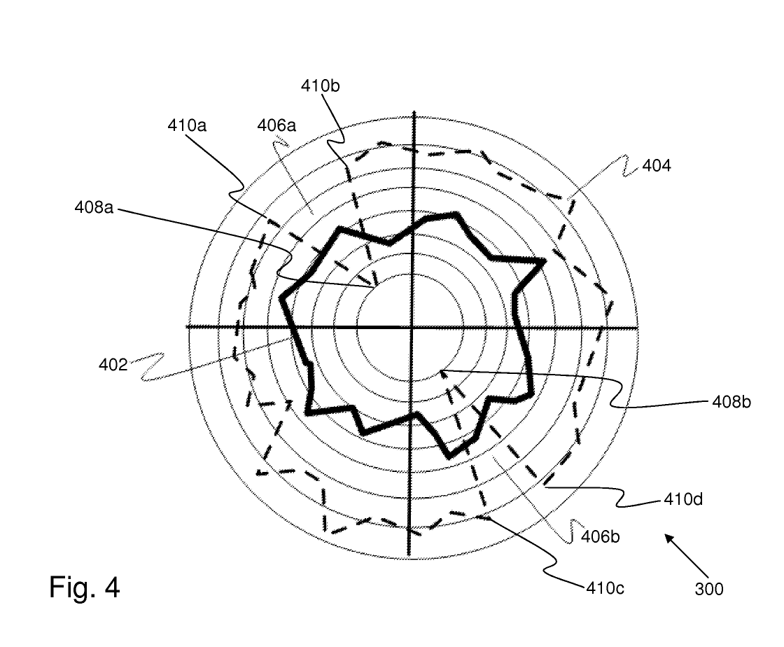

The developmental-balance level may, for example, be indicative of activity topics and/or activity dimensions in which he/she has advanced the most, and/or activity topics and/or activity dimensions in which he/she has advanced the least. Details of the developmental-balance level have been provided in conjunction with FIG. 4.

Continuing from the example scenario, let us also assume that the users B and C are teachers, who are allowed by the developmental-evaluation service to keep a track of progress shown by the student, i.e., the user A. The teachers use the developmental-evaluation service to perform at least one of the following tasks:

(a) assess the recorded user performance of the student in the selected developmental activity;
(b) modify the recorded user performance, for example, in a situation where the student recorded his/her performance him/herself manually;
(c) award the point value to the user score in the activity topic and/or the activity dimension associated with the selected developmental activity, in accordance with the recorded user performance;
(d) approve the user score;
(e) assess the developmental-balance level of the student; and/or
(f) create one or more tests to be given to one or more students.

Moreover, the developmental-evaluation service enables the teachers to interact and/or share information with each other. In an embodiment, each teacher is allowed to access entries related to other teachers. In another embodiment, the teachers are provided a limited access to the entries related to other teachers. In one example, the teachers may be allowed to access entries related to an activity topic and/or an activity dimension that is associated with them in common. In another example, the teachers may be allowed to access entries related to an activity topic and/or an activity dimension whose access rights are set as “open” for them. Such access rights may be set and/or modified by a system administrator.

Furthermore, the developmental-evaluation service can be offered free of cost. Alternatively, the developmental-evaluation service can be a paid service that has a subscription-based billing or a transaction-based billing, such as pay-per-use and pay-per-feature.

FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of data processing units, servers, databases and communication networks. A person skilled in the art will recognize many variations, alternatives, and modifications of embodiments of the present disclosure.

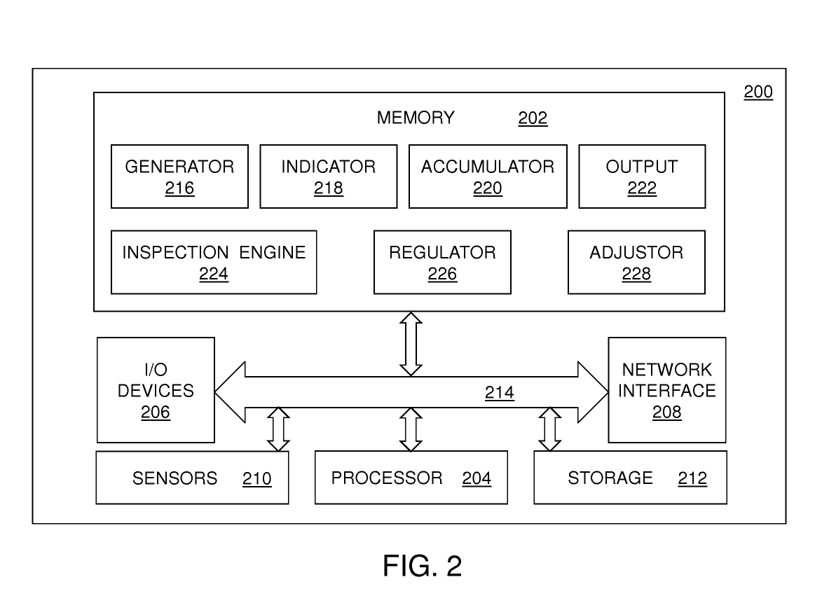

FIG. 2 is a schematic illustration of various components of a data processing unit 200, in accordance with an embodiment of the present disclosure. The data processing unit 200 could be implemented as the data processing units 102, and vice versa. The data processing unit 200 includes, but is not limited to, a data memory 202, a computing hardware such as a processor 204, Input/Output (I/O) devices 206, a network interface 208, a configuration of sensors 210, a storage 212, and a system bus 214 that operatively couples various components including the data memory 202, the processor 204, the I/O devices 206, the network interface 208, the sensors 210 and the storage 212. The I/O devices 206 include a display screen for presenting graphical images to a user of the data processing unit 200.

The data processing unit 200 also includes a power source (not shown in FIG. 2) for supplying electrical power to the various components of the data processing unit 200. The power source may, for example, include a rechargeable battery.

The data memory 202 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

The data memory 202 stores a generator 216, an indicator 218, an accumulator 220, an output 222, a comparison engine 224, a regulator 226, and an adjustor 228. The generator 216, the indicator 218, the accumulator 220, the output 222, the comparison engine 224, the regulator 226, and the adjustor 228 may, for example, be parts of a software product associated with the developmental-evaluation service provided by the server 104. Executing the software product on the processor 204 results in generating and rendering a graphical user interface on the display screen. The graphical user interface is configured to facilitate user interactions with the developmental-evaluation service.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, the I/O devices 206 include a mouse or a joystick that is operable to receive inputs corresponding to clicking, pointing, and/or moving a pointer object on the graphical user interface. The I/O devices 206 may also include a keyboard that is operable to receive inputs corresponding to pushing certain buttons on the keyboard.

Additionally, the I/O devices 206 may also include a microphone for receiving an audio input from the user, and a speaker for providing an audio output to the user.

Moreover, the sensors 210 may include one or more of: an accelerometer, a magnetometer, a pressure sensor, a temperature sensor, a gyroscopic sensor, a Global Positioning System (GPS) sensor, or a timer. The sensors 210 may be used to measure and collect data related to surroundings of the user. Additionally, outputs generated by the sensors 210 may, for example, be indicative of movements of the user as a function of time.

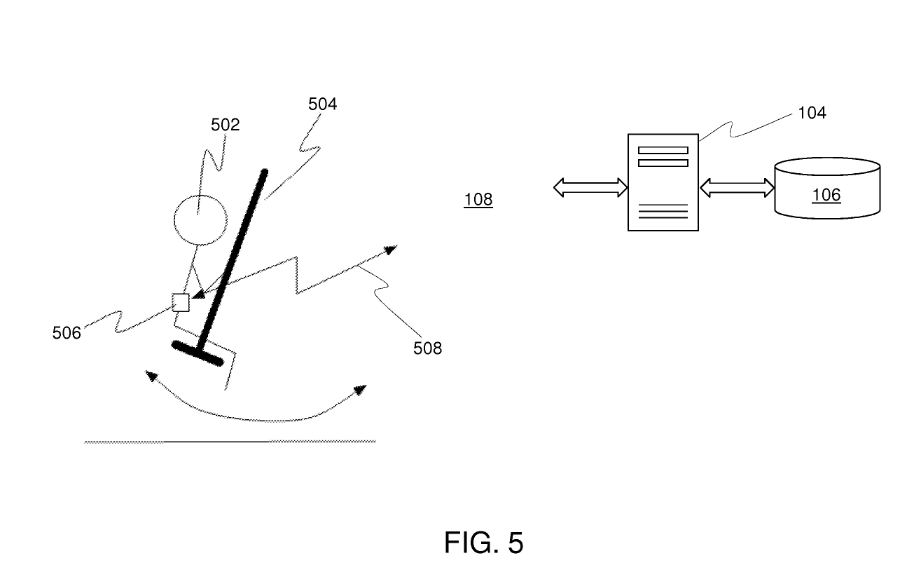

In some examples, the software product may be interfaced with the sensors 210. When executed on processor 204, the software product is configured to resolve and integrate the outputs of the sensors 210 into useful information about at least one of: one or more movements (for example, accelerations and/or rotations and/or orientations) of the user, one or more spatial positions of the user, and associated time-stamps. Details of how the sensors 210 may be used to measure a user performance of an example developmental activity have been provided in conjunction with FIG. 5.

In some examples, the sensors 210 may include a GPS sensor for determining one or more absolute spatial positions of the user upon a surface of the Earth.

In some examples, the sensors 210 may include a timer for including the time-stamps with selected and performed developmental activities. Alternatively, processor 204 may provide system time as reference for including the time-stamps with the selected and performed developmental activities.

Moreover, the storage 212 is a non-transient data storage medium. The software product, when executed on the processor 204, is optionally coupled to the storage 212, and is configured to substantially continuously record and update changes in status of a developmental activity being performed by the user in the storage 212. The software product, when executed on the processor 204, is optionally configured to resume the status of the developmental activity to its last updated status in the storage 212, in case of interruptions in the operable state of the graphical user interface.

Additionally, the software product, when executed on the processor 204, may store user-related information in the storage 212. The user-related information of a particular student may, for example, include at least one of: a user account of that particular student, individual user scores of that particular student in various developmental activities, accumulated user scores of that particular student in various activity topics and/or activity dimensions, a reporting reliability factor of that particular student, a developmental-balance level of that particular student, and/or associated time-stamps.

Furthermore, the network interface 208 optionally allows the data processing unit 200 to upload the user-related information to the server 104, for example, via the communication network 108. Additionally, the network interface 208 may allow the data processing unit 200 to access the server 104 to update the software product and/or download one or more new software products associated with the developmental-evaluation service.

Moreover, the network interface 208 optionally allows the data processing unit 200 to communicate with other data processing units, for example, via the communication network 108.

The data processing unit 200 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

When executed on the processor 204, the generator 216 is configured to present the user with a menu of developmental activities in which each developmental activity is associated with at least one of a plurality of activity topics and/or at least one of a plurality of activity dimensions.

When executed on the processor 204, the indicator 218 is configured to receive a user input selecting a developmental activity from the menu. The generator 216, when executed on the processor 204, may also be configured to present the user with a description of the selected developmental activity, for example, via a web page, a document, a video clip, and/or an audio clip. The description may, for example, include instructions for performing the selected developmental activity and/or information about objective of the selected developmental activity.

When executed on the processor 204, the software product is configured to determine an activity type for the selected developmental activity. The activity type indicates whether the selected developmental activity is suitable or otherwise conducive to automatic tracking by the data processing unit 200. If the selected developmental activity is conducive to automatic tracking, the user performance is recorded and reported automatically. Examples of developmental activities that may be conducive to automatic tracking include, but are not limited to, movements that can be tracked using the sensors 210, audio and speaking tasks that can be tracked using the microphone, online assignments, online projects, collaborative projects performed by groups of students, and/or tasks that can be performed with a software application on the data processing unit 200, such as colouring tasks and mathematical tasks.

Otherwise, if the selected developmental activity is not conducive to automatic tracking, the software product, when executed on the processor 204, is configured to enable the user to record and report his/her performance manually. The manual reporting is subjected to calibration to take into consideration the user's tendency of subjective analysis of the selected developmental activity.

In order to calibrate the manual reporting, the adjustor 228, when executed on the processor 204, is configured to establish a reporting reliability factor of the user by comparing a manually-reported user performance of the selected developmental activity with an automatically-reported user performance of the selected developmental activity. The adjustor 228, when executed on the processor 204, is configured to modify future manually-reported user performances using the reporting reliability factor of the user.

Additionally, the adjustor 228, when executed on the processor 204, is configured to re-establish the reporting reliability factor periodically or randomly from time to time.

When executed on the processor 204, the software product is configured to award a point value to a user score in an activity topic and/or an activity dimension associated with the selected developmental activity. In some examples, the software product, when executed on the processor 204, may be configured to present to the user a user performance output on the display screen of the data processing unit 200.

When executed on the processor 204, the accumulator 220 is configured to assemble user scores from point values awarded within activity topics and activity dimensions associated with various selected and performed developmental activities.

When executed on the processor 204, the comparison engine 224 is configured to compare the user scores across the activity topics and/or the activity dimensions to determine whether the user scores are balanced.

When executed on the processor 204, the regulator 226 is configured to influence the user to perform one or more developmental activities from activity topics and/or activity dimensions that contribute to balancing user scores across all activity topics and activity dimensions.

In one example, the generator 216, when executed on the processor 204, may be configured to prevent presentation of developmental activities from those activity topics and/or activity dimensions in which the user has advanced the most. In another example, the generator 216, when executed on the processor 204, may be configured to present developmental activities from only those activity topics and/or activity dimensions in which the user has advanced the least. These example configurations ensure that the user selects and performs developmental activities from activity topics and/or activity dimensions in which he/she is lagging.

When executed on the processor 204, the output 222 is configured to demonstrate a developmental-balance level of the user, and to render a mapping of a closed developmental-balance curve within a spatial arrangement of activity topics and activity dimensions.

The output 222, when executed on the processor 204, is further configured to greatly vary a distance of points on the closed developmental-balance curve from a given point bounded by the closed developmental-balance curve when the developmental-balance level is low.

The output 222, when executed on the processor 204, is further configured to expand the closed developmental-balance curve in a space of the mapping when a pre-defined user score for advancing within an activity topic or an activity dimension associated with that space has been reached.

Details of how the developmental-balance level is demonstrated have been provided in conjunction with FIG. 4.

FIG. 2 is merely an example, which should not unduly limit the scope of the claims herein. It is to be understood that the specific designation for the data processing unit 200 is provided as an example and is not to be construed as limiting the data processing unit 200 to specific numbers, types, or arrangements of modules and/or components of the data processing unit 200. A person skilled in the art will recognize many variations, alternatives, and modifications of embodiments of the present disclosure.

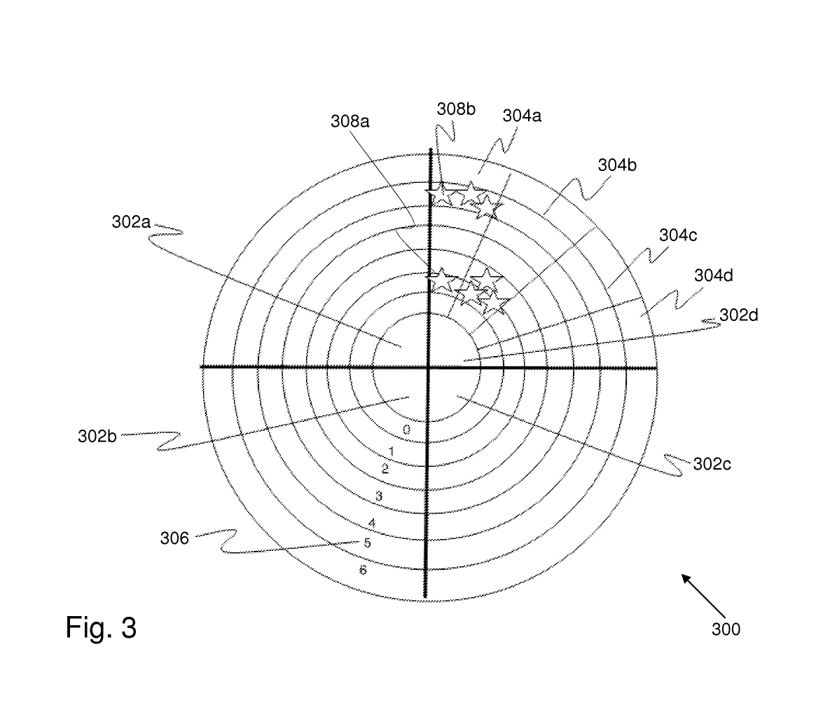

FIG. 3 is a schematic illustration of an example chart 300 of activity topics and activity dimensions, in accordance with an embodiment of the present disclosure. The output 222, when executed on the processor 204, is configured to present the example chart 300 on the graphical user interface generated and rendered on the display screen of the data processing unit 200.

The example chart 300 shows a plurality of activity dimensions, depicted as an activity dimension 302a, an activity dimension 302b, an activity dimension 302c and an activity dimension 302d (hereinafter collectively referred to as activity dimensions 302). With reference to FIG. 3, the example chart 300 has been represented by a circle, while the activity dimensions 302 have been represented by four sectors of the circle.

The activity dimensions 302 are further divided into activity topics. In FIG. 3, the activity dimension 302d is divided into a plurality of activity topics, depicted as an activity topic 304a, an activity topic 304b, an activity topic 304c and an activity topic 304d (hereinafter collectively referred to as activity topics 304). It is to be noted here that a number of activity topics within an activity dimension is not limited to a particular number. Different activity dimensions may be divided into different number of activity topics, irrespective of each other.

Furthermore, each activity topic may be divided into various paths, which may include various developmental activities corresponding to various levels of development. Details of these paths have been provided in conjunction with example tables below.

Additionally, the example chart 300 includes concentric circles arranged such that circles having greater circumferences surround circles having lesser circumferences. Level numbers 306 in between the concentric circles represent various levels of development within each activity topic and/or activity dimension. In one embodiment, the level numbers 306 correspond to an age of a student. For example, a level number ‘0’ may correspond to an age of zero years, a level number ‘1’ may correspond to an age of one years, a level number ‘2’ may correspond to an age of two years, and so on. In another embodiment, the level numbers 306 correspond to a time period for which the developmental-evaluation service has been in use for the student.

Moreover, each of the activity topics 304 includes one or more developmental activities corresponding to the various levels of development. These developmental activities may be physical activities, mental activities, or combinations thereof. Additionally, the developmental activities may be performed with the data processing unit 200 and/or other accessories, such as a pen and a paper.

With reference to FIG. 3, the activity topic 304a includes developmental activities 308a and developmental activities 308b. The developmental activities 308a are activities to be performed at a level number ‘1’, while the developmental activities 308b are activities to be performed at a level number ‘5’.

When the student successfully performs some or all of developmental activities in a lower level, he/she is advanced to a next higher level. Details of how the student may be advanced from one level to another have been provided in conjunction with FIG. 4.

FIG. 3 is merely an example, which should not unduly limit the scope of the claims herein. A person skilled in the art will recognize many variations, alternatives, and modifications of embodiments of the present disclosure. For example, a chart may include concentric shapes other than circles, wherein shapes having greater perimeters surround shapes having lesser perimeters.

For illustration purposes only, let us consider that the activity dimension 302a is a cognitive dimension, the activity dimension 302b is a social dimension, the activity dimension 302c is a cultural dimension, and the activity dimension 302d is a neuro-biological dimension.

The cognitive dimension corresponds to development of basic academic skills of the student, and may be divided into four activity topics, namely, language, mathematics, geography, and biology.

An example table ‘Cognitive Dimension—Table 1’ illustrates various developmental activities that may be performed under the activity topic “language” of the cognitive dimension.

TABLE 1
Cognitive Dimension
Activity Topic “Language”

| Path 1: Developing | | |
|---|---|---|
| Verbal Communication | Path 2: Developing | Path 3: Developing |
| Skills, and Linguistic | Reading and | Creative Story-telling |
| Tools of Mind | Writing Skills | Competence |
| Initial Language 0 | — | Books 0 |
| Initial Language 1 | — | Books 1 |
| Linguistic Skills 2 | Exploring Language 2 | Books 2 |
| Linguistic Skills 3 | Initial Reading | Books 3, |
| | and Writing 3 | Story-telling 3 |
| Linguistic Skills 4 | Reading and Writing 4 | Books 4, |
| | | Story-telling 4 |
| Linguistic Skills 5 | Reading and Writing 5 | Books 5, |
| | | Story-telling 5 |
| Linguistic Skills 6 | Reading and Writing 6 | Books 6, |
| | | Story-telling 6 |

With reference to the example table ‘Cognitive Dimension—Table 1’, the activity topic “language” is divided into three paths that include developmental activities, namely, for developing verbal communication skills and linguistic tools of mind; developing reading and writing skills; and developing creative story-telling competence. These developmental activities may, for example, include exploring language, reading, writing, and story-telling.

An example table ‘Cognitive Dimension—Table 2’ illustrates various developmental activities that may be performed under the activity topic “mathematics” of the cognitive dimension.

TABLE 2
Cognitive Dimension
Activity Topic “Mathematics”

| Path 1: Developing | Path 2: Developing | Path 3: Developing |
|---|---|---|
| Scientific | Geometric | Arithmetic |
| Tools of Mind | Tools of Mind | Tools of Mind |
| Initial Mathematics and | — | — |
| Science Impressions 0 | | |
| Initial Science | Initial Geometry 1 | Initial Arithmetic 1 |
| Exploration 1 | | |
| Exploring Science 2 | Exploring Geometry 2 | Exploring Arithmetic 2 |
| Exploring Science 3 | Exploring Geometry 3 | Exploring Arithmetic 3 |
| Science, Inquiry 4 | Comprehending | Comprehending |
| | Geometry 4 | Arithmetic 4 |
| Science, Inquiry 5 | Comprehending | Comprehending |
| | Geometry 5 | Arithmetic 5 |
| Science, Inquiry 6 | Comprehending | Comprehending |
| | Geometry 6 | Arithmetic 6 |

With reference to the example table ‘Cognitive Dimension—Table 2’, the activity topic “mathematics” is divided into three paths that include developmental activities, namely, for developing scientific tools of mind; developing geometric tools of mind; and developing arithmetic tools of mind. These developmental activities may, for example, include exploring science, geometry and arithmetic, inquiring about scientific reasons, and comprehending geometry and arithmetic.

An example table ‘Cognitive Dimension—Table 3’ illustrates various developmental activities that may be performed under the activity topic “geography” of the cognitive dimension.

TABLE 3
Cognitive Dimension
Activity Topic “Geography”

| Path 1: Developing an | Path 2: Developing a | Path 3: Developing a |
|---|---|---|
| Ecological Awareness | Global Awareness of | Cyclic Awareness of |
| of Planet Earth and | Planet Earth | Planet Earth |
| its Resources | as a Home of People | in Universe |
| Initial Impressions of | — | — |
| Geographical | | |
| Environment 0 | | |
| Initial Impressions of | — | — |
| Geographical | | |
| Environment 1 | | |
| Exploring Ecological | Exploring Globe, | Exploring Cylces of |
| Environment 2 | Home of People 2 | Earth in Universe 2 |
| Exploring Ecological | Exploring Globe, | Exploring Cylces of |
| Environment 3 | Home of People 3 | Earth in Universe 3 |
| Exploring Ecological | Exploring Globe, | Exploring Cylces of |
| Environment 4 | Home of People 4 | Earth in Universe 4 |
| Exploring Ecological | Exploring Globe, | Exploring Cylces of |
| Environment 5 | Home of People 5 | Earth in Universe 5 |
| Exploring Ecological | Exploring Globe, | Exploring Cylces of |
| Environment 6 | Home of People 6 | Earth in Universe 6 |

With reference to the example table ‘Cognitive Dimension—Table 3’, the activity topic “geography” is divided into three paths that include developmental activities, namely, for developing an ecological awareness of planet Earth and its resources; developing a global awareness of planet Earth as a home of people; and developing a cyclic awareness of planet Earth in the universe. These developmental activities may, for example, include exploring ecological environment, globe, and cycles of Earth.

An example table ‘Cognitive Dimension—Table 4’ illustrates various developmental activities that may be performed under the activity topic “biology” of the cognitive dimension.

TABLE 4
Cognitive Dimension
Activity Topic “Biology”

| Path 1: Developing an | Path 2: Developing an | Path 3: Developing an |
|---|---|---|
| Understanding of | Understanding of | Understanding of |
| Plant Life | Animal Life | Eras of Life on Earth |
| Initial Impressions | — | — |
| of Natural | | |
| Environment 0 | | |
| Initial Impressions | — | — |
| of Natural | | |
| Environment 1 | | |
| Exploring Plant Life 2 | Exploring Animal | Exploring History of |
| | Life 2 | Life 2 |
| Exploring Plant Life 3 | Exploring Animal | Exploring History of |
| | Life 3 | Life 3 |
| Exploring Plant Life 4 | Exploring Animal | Exploring History of |
| | Life 4 | Life 4 |
| Exploring Plant Life 5 | Exploring Animal | Exploring History of |
| | Life 5 | Life 5 |
| Exploring Plant Life 6 | Exploring Animal | Exploring History of |
| | Life 6 | Life 6 |

With reference to the example table ‘Cognitive Dimension—Table 4’, the activity topic “biology” is divided into three paths that include developmental activities, namely, for developing an understanding of plant life; developing an understanding of animal life; and developing an understanding of eras of life on Earth. These developmental activities may, for example, include exploring plant life, animal life and history of life.

The social dimension corresponds to development of collaborative and creative knowledge building skills of the student, and may be divided into four activity topics, namely, expressive modalities, digital media, project work, and construction play.

An example table ‘Social Dimension—Table 1’ illustrates various developmental activities that may be performed under the activity topic “expressive modalities” of the social dimension.

TABLE 1
Social Dimension
Activity Topic “Expressive Modalities”

| Path 1: Developing | Path 2: Developing | Path 3: Developing |
|---|---|---|
| Multi-Modal | Cross-Modal | Graphic |
| Visualization | Representation | Representation |
| Tools of Mind | Skills | Skills |
| Initial Opportunities to | — | — |
| Explore Expressive | | |
| Modalities 0 | | |
| Exploring Multiple | — | Plastic Expression 1 |
| Expressive Modalities 1 | | |
| Exploring Multiple | Cross-Modal | Plastic Expression 2 |
| Expressive Modalities 2 | Exploration 2 | |
| Exploring Multiple | Cross-Modal | Plastic Expression 3 |
| Expressive Modalities 3 | Exploration 3 | |
| Exploring Multiple | Cross-Modal | Graphic and Plastic |
| Expressive Modalities 4 | Representation 4 | Expression 4 |
| Exploring Multiple | Cross-Modal | Graphic and Plastic |
| Expressive Modalities 5 | Representation 5 | Expression 5 |
| Exploring Multiple | Cross-Modal | Graphic and Plastic |
| Expressive Modalities 6 | Representation 6 | Expression 6 |

With reference to the example table ‘Social Dimension—Table 1’, the activity topic “expressive modalities” is divided into three paths that include developmental activities, namely, for developing multi-modal visualization tools of mind; developing cross-modal representation skills; and developing graphic representation skills. These developmental activities may, for example, include exploring multiple expressive modalities, cross-modal representations, and graphic and plastic expressions.

An example table ‘Social Dimension—Table 2’ illustrates various developmental activities that may be performed under the activity topic “digital media” of the social dimension.

TABLE 2
Social Dimension
Activity Topic “Digital Media”

| Path 1: Developing | Path 2: Developing | Path 3: Developing |
|---|---|---|
| Digitally-Supported | Digital | Digital |
| Knowledge Building Tools | Visualization Skills | Media Competence |
| Initial Virtual Opportunities | — | — |
| and Experiences 0 | | |
| Creating Virtual Landscapes | — | Initial Digital |
| 1 | | Exploration 1 |
| Creating Virtual Landscapes | — | Initial Digital |
| 2 | | Exploration 2 |
| Creating Virtual Landscapes | Digital | Digital Tools 3 |
| 3 | Representation 3 | |
| Digitally Supported | Digital | Digital Tools 4 |
| Knowledge Building, Virtual | Representation 4 | |
| Landscapes 4 | | |
| Digitally Supported | Digital | Digital Tools 5 |
| Knowledge Building, Virtual | Representation 5 | |
| Landscapes 5 | | |
| Digitally Supported | Digital | Digital Tools 6 |
| Knowledge Building, Virtual | Representation 6 | |
| Landscapes 6 | | |

With reference to the example table ‘Social Dimension—Table 2’, the activity topic “digital media” is divided into three paths that include developmental activities, namely, for developing digitally-supported knowledge building tools; developing digital visualization skills; and developing digital media competence. These developmental activities may, for example, include creating virtual landscapes and using digital tools.

An example table ‘Social Dimension—Table 3’ illustrates various developmental activities that may be performed under the activity topic “project work” of the social dimension.

TABLE 3
Social Dimension
Activity Topic “Project Work”

| | Path 2: Developing | Path 3: Developing |
|---|---|---|
| Path 1: Developing | Orientation to Idea | Orientation to |
| Collaborative Knowledge | Improvement as a | Learning as |
| Building Skills | Habit of Mind | Knowledge Building |
| Initial Opportunities to | — | — |
| Thematic Experiences 0 | | |
| Initial Opportunities to | — | — |
| Thematic Experiences 1 | | |
| Initial Opportunities to | — | — |
| Thematic Experiences 2 | | |
| Collaborative Knowledge | Idea Elaboration 3 | Creative Problem |
| Building Project Work 3 | | Solving 3 |
| Collaborative Knowledge | Idea Elaboration 4 | Creative Problem |
| Building Project Work 4 | | Solving 4 |
| Collaborative Knowledge | Idea Elaboration 5 | Creative Problem |
| Building Project Work 5 | | Solving 5 |
| Collaborative Knowledge | Idea Elaboration 6 | Creative Problem |
| Building Project Work 6 | | Solving 6 |

With reference to the example table ‘Social Dimension—Table 3’, the activity topic “project work” is divided into three paths that include developmental activities, namely, for developing collaborative knowledge building skills; developing orientation to idea improvement as a habit of mind; and developing orientation to learning as knowledge building. These developmental activities may, for example, include collaborative knowledge-building project work, elaborating ideas, and creative problem solving.

An example table ‘Social Dimension—Table 4’ illustrates various developmental activities that may be performed under the activity topic “construction play” of the social dimension.

TABLE 4
Social Dimension
Activity Topic “Construction Play”

| Path 1: Developing | | Path 3: Developing |
|---|---|---|
| Abilities to Fuse | Path 2: Developing | Spatial |
| Fact and Fantasy | 3D Tools of Mind | Visualization Skills |
| Initial Opportunities to | — | — |
| Material Exploration 0 | | |
| Material Exploration 1, | Animal Homes, Hut | — |
| Blocks 1 | Building 1 | |
| Material Exploration 2, | Animal Homes, Hut | Thematic |
| Blocks 2 | Building 2 | Constructions 2 |
| Material Exploration 3, | Animal Homes, Hut | Thematic |
| Blocks 3 | Building 3 | Constructions 3 |
| Construction Play 4, | Animal Homes, Hut | Thematic |
| Material | Building 4 | Constructions 4 |
| Exploration 4, Blocks 4 | | |
| Construction Play 5, | Hut Building 5, Building | Thematic |
| Material | Geometry 5, Architecture | Constructions 5 |
| Exploration 5, Blocks 5 | and Engineering 5 | |
| Construction Play 6, | Hut Building 6, Building | Thematic |
| Material | Geometry 6, Architecture | Constructions 6 |
| Exploration 6, Blocks 6 | and Engineering 6 | |

With reference to the example table ‘Social Dimension—Table 4’, the activity topic “construction play” is divided into three paths that include developmental activities, namely, for developing abilities to fuse fact and fantasy; developing three-dimensional (3D) tools of mind; and developing spatial visualization skills. These developmental activities may, for example, include exploring material, playing with blocks, building animal homes and huts, and making thematic constructions.

The cultural dimension corresponds to development of cultural values and identity of the student, and may be divided into four activity topics, namely, local culture, ethics and values, practical life and domestic play, and role play and drama play.

An example table ‘Cultural Dimension—Table 1’ illustrates various developmental activities that may be performed under the activity topic “local culture” of the cultural dimension.

TABLE 1
Cultural Dimension
Activity Topic “Local Culture”

| Path 1: Developing | Path 2: Connecting with | |
|---|---|---|
| Musical | Cultural Background and | Path 3: Developing |
| Cultural Tools | Identity | Cultural Awareness |
| — | Initial Rhymes, Poems, | — |
| | Tales and Sagas 0 | |
| Instruments 1, Songs 1 | Rhymes, Poems, | Global Orientation 1 |
| | Tales and Sagas 1 | |
| Instruments 2, Songs 2 | Rhymes, Poems, | Global Orientation 2 |
| | Tales and Sagas 2 | |
| Instruments 3, Songs 3, | Rhymes, Poems, | Global Orientation 3 |
| Singing 3 | Tales and Sagas 3 | |
| Instruments 4, Songs 4, | Rhymes, Poems, | Global Orientation 4 |
| Singing 4 | Tales and Sagas 4 | |
| Instruments 5, Songs 5, | Rhymes, Poems, | Global Orientation 5 |
| Singing 5 | Tales and Sagas 5 | |
| Instruments 6, Songs 6, | Rhymes, Poems, | Global Orientation 6 |
| Singing 6 | Tales and Sagas 6 | |

With reference to the example table ‘Cultural Dimension—Table 1’, the activity topic “local culture” is divided into three paths that include developmental activities, namely, for developing musical cultural tools; connecting with cultural background and identity; and developing cultural awareness. These developmental activities may, for example, include exploring musical instruments, and learning rhymes, poems, tales and songs.

An example table ‘Cultural Dimension—Table 2’ illustrates various developmental activities that may be performed under the activity topic “ethics and values” of the cultural dimension.

TABLE 2
Cultural Dimension
Activity Topic “Ethics and Values”

| Path 1: Developing | Path 2: Developing | Path 3: Developing |
|---|---|---|
| Ethical Behaviour | Social Skills | Executive Function |
| — | Initial Respect of Others, | Initial Self-Control 0 |
| Local Values 1 | Initial Good Manners 1, | Initial Organizational |
| | Table Manners 1 | Skills 1 |
| Local Values 2 | Good Manners 2, Table | Organizational Skills 2 |
| | Manners 2 | |
| Local Values 3 | Grace and Courtesy 3, | Organizational Skills 3 |
| | Table Manners 3 | |
| Local Values 4 | Grace and Courtesy 4, | Organizational Skills 4 |
| | Table Manners 4 | |
| Local Values 5 | Grace and Courtesy 5, | Organizational Skills 5 |
| | Table Manners 5 | |
| Local Values 6 | Grace and Courtesy 6, | Organizational Skills 6 |
| | Table Manners 6 | |

With reference to the example table ‘Cultural Dimension—Table 2’, the activity topic “ethics and values” is divided into three paths that include developmental activities, namely, for developing ethical behaviour; developing social skills; and developing executive function. These developmental activities may, for example, include learning local values, good manners, table manners, grace and courtesy, and organizational skills.

An example table ‘Cultural Dimension—Table 3’ illustrates various developmental activities that may be performed under the activity topic “practical life and domestic play” of the cultural dimension.

TABLE 3
Cultural Dimension
Activity Topic “Practical Life and Domestic Play”

| Path 1: Developing | Path 2: Developing | |
|---|---|---|
| Environmental | Environmental | |
| Responsibilities | Responsibilities | Path 3: Developing |
| Outdoor | Indoor | Independence |
| Initial Respect of | — | — |
| Outdoor | | |
| Environment | | |
| Initial Care of | Initial Care of Indoor | Self-Care 1 |
| Outdoor | Environment 1, Domestic | |
| Environment 1 | Play 1 | |
| Care of Outdoor | Care of Indoor Environment | Self-Care 2 |
| Environment 2 | 2, Domestic Play 2 | |
| Care of Outdoor | Care of Indoor Environment | Self-Care 3 |
| Environment 3 | 3, Domestic Play 3 | |
| Care of Outdoor | Care of Indoor Environment | Self-Care 4 |
| Environment 4 | 4, Domestic Play 4 | |
| Care of Outdoor | Care of Indoor Environment | Self-Care 5 |
| Environment 5 | 5, Domestic Play 5 | |
| Care of Outdoor | Care of Indoor Environment | Self-Care 6 |
| Environment 6 | 6, Domestic Play 6 | |

With reference to the example table ‘Cultural Dimension—Table 3’, the activity topic “practical life and domestic play” is divided into three paths that include developmental activities, namely, for developing environmental responsibilities outdoor; developing environmental responsibilities indoor; and developing independence. These developmental activities may, for example, include taking care of outdoor and indoor environment, performing domestic play, and learning self-care.

An example table ‘Cultural Dimension—Table 4’ illustrates various developmental activities that may be performed under the activity topic “role play and drama play” of the cultural dimension.

TABLE 4
Cultural Dimension
Activity Topic “Role Play and Drama Play”

| | Path 2: Developing | Path 3: Developing |
|---|---|---|
| | Ability to | Ability to |
| Path 1: Nurturing | Embrace Ambiguity, | Emphasize and Relate |
| Playfulness | Surprise and | to Objects of |
| and Humor | the Unexpected | Studied Themes |
| Initial Puppet | — | — |
| Play 0 | | |
| Initial Puppet | Initial Drama Play 1 | Initial Role Play 1 |
| Play 1 | | |
| Puppet Play 2 | Drama Play 2 | Role Play 2 |
| Puppet Play 3 | Drama Play 3 | Role Play 3, Thematic Live |
| | | Action Role Play 3 |
| Puppet Play 4 | Drama Play 4 | Role Play 4, Thematic Live |
| | | Action Role Play 4 |
| Puppet Play 5 | Drama Play 5 | Role Play 5, Thematic Live |
| | | Action Role Play 5 |
| Puppet Play 6 | Drama Play 6 | Role Play 6, Thematic Live |
| | | Action Role Play 6 |

With reference to the example table ‘Cultural Dimension—Table 4’, the activity topic “role play and drama play” is divided into three paths that include developmental activities, namely, for nurturing playfulness and humour; developing ability to embrace ambiguity, surprise and the unexpected; and developing ability to emphasize and relate to objects of studied themes. These developmental activities may, for example, include performing puppet play, drama play and role play.

The neuro-biological dimension corresponds to development of sensory and motor functions of the student, and may be divided into four activity topics, namely, sensory, motor, integrative, and movement.

For illustration purposes only, let us consider that the activity topic 304a is the activity topic “sensory”, the activity topic 304b is the activity topic “motor”, the activity topic 304c is the activity topic “integrative”, and the activity topic 304d is the activity topic “movement”.

An example table ‘Neuro-Biological Dimension—Table 1’ illustrates various developmental activities that may be performed under the activity topic “sensory” of the neuro-biological dimension.

TABLE 1
Neuro-Biological Dimension
Activity Topic “Sensory”

| Path 1: Refining | Path 2: Refining | Path 3: Refining |
|---|---|---|
| Visual Senses | Auditory Senses | Tactile Senses |
| Visual | Auditory | Tactile |
| Opportunities 0 | Opportunities 0 | Opportunities 0 |
| Visual | Auditory | Tactile |
| Opportunities 1 | Opportunities 1 | Opportunities 1 |
| Visual Activities 2 | Auditory Activities 2 | Tactile Activities 2 |
| Visual Activities 3 | Auditory Activities 3 | Tactile Activities 3 |
| Visual Activities 4 | Auditory Activities 4 | Tactile Activities 4 |
| Visual Activities 5 | Auditory Activities 5 | Tactile Activities 5 |
| Visual Activities 6 | Auditory Activities 6 | Tactile Activities 6 |

With reference to the example table ‘Neuro-Biological Dimension—Table 1’, the activity topic “sensory” is divided into three paths that include developmental activities, namely, for refining visual senses; refining auditory senses; and refining tactile senses. These developmental activities may, for example, include exploring and identifying art; discriminating between sounds, such as nature sounds, techno sounds, human sounds, and domestic sounds; learning tone bars; classifying colour tables; exploring and identifying textures; and so on.

An example table ‘Neuro-Biological Dimension—Table 2’ illustrates various developmental activities that may be performed under the activity topic “integrative” of the neuro-biological dimension.

TABLE 2
Neuro-Biological Dimension
Activity Topic “Integrative”

| | | Path 3: Organizing |
|---|---|---|
| Path 1: Refining | Path 2: Refining | and Integrating |
| Gustatory and | Vestibular and | Sensory and |
| Olfactory Senses | Proprioceptive Senses | Motor Process |
| Gustatory and Olfactory | Vestibular and | Integrative |
| Opportunities 0 | Proprioceptive | Opportunities 0 |
| | Opportunities 0 | |
| Gustatory and Olfactory | Vestibular and | Integrative |
| Opportunities 1 | Proprioceptive | Opportunities 1 |
| | Opportunities 1 | |
| Gustatory and Olfactory | Vestibular and | Integrative Activities 2 |
| Activities 2 | Proprioceptive | |
| | Activities 2 | |
| Gustatory and Olfactory | Vestibular and | Integrative Activities 3 |
| Activities 3 | Proprioceptive | |
| | Activities 3 | |
| Gustatory and Olfactory | Vestibular and | Integrative Activities 4 |
| Activities 4 | Proprioceptive | |
| | Activities 4 | |
| Gustatory and Olfactory | Vestibular and | Integrative Activities 5 |
| Activities 5 | Proprioceptive | |
| | Activities 5 | |
| Gustatory and Olfactory | Vestibular and | Integrative Activities 6 |
| Activities 6 | Proprioceptive | |
| | Activities 6 | |

With reference to the example table ‘Neuro-Biological Dimension—Table 2’, the activity topic “integrative” is divided into three paths that include developmental activities, namely, for refining gustatory and olfactory senses; refining vestibular and proprioceptive senses; and organizing and integrating sensory and motor process. These developmental activities may, for example, include discriminating between various tastes, smells, touches.

An example table ‘Neuro-Biological Dimension—Table 3’ illustrates various developmental activities that may be performed under the activity topic “motor basics” of the neuro-biological dimension.

TABLE 3
Neuro-Biological Dimension
Activity Topic “Motor Basics”

| Path 1: Developing | Path 2: Developing | Path 3: Developing |
|---|---|---|
| Fine Motor Control | Body Control, | Aerobic Fitness, |
| and Hand- | Balance and Self- | Flexibility |
| Eye Coordination | Regulation | and Poise |
| Manual Basics | Tumbling Play | Gross-Motor Basics 0 |
| Opportunities 0 | Opportunities 0 | |
| Manual Basics | Strenuous Play | Gross-Motor Basics 1 |
| Opportunities 1 | Opportunities 1 | |
| Manual Basics 2 | Strenuous Play | Gross-Motor Basics 2: |
| | Activities 2 | Running |
| Manual Skills 3 | Strenuous Play | Gross-Motor Basics 3: |
| | Activities 3 | Running |
| Manual Skills 4: | Strenuous Play | Gross-Motor Basics 4: |
| Juggling | Activities 4 | Running |
| Manual Skills 5: | Strenuous Play | Gross-Motor Basics 5: |
| Juggling | Activities 5 | Running |
| Manual Skills 6: | Strenuous Play | Gross-Motor Basics 6: |
| Juggling | Activities 6 | Running |

With reference to the example table ‘Neuro-Biological Dimension—Table 3’, the activity topic “motor basics” is divided into three paths that include developmental activities, namely, for developing fine motor control and hand-eye coordination; developing body control, balance and self-regulation; and developing aerobic fitness, flexibility and poise. These developmental activities may, for example, include juggling, swimming, walking, running, dancing, and so on.

An example table ‘Neuro-Biological Dimension—Table 4’ illustrates various developmental activities that may be performed under the activity topic “movement basics” of the neuro-biological dimension.

TABLE 4
Neuro-Biological Dimension
Activity Topic “Movement Basics”

| Path 1: Developing | Path 2: Developing | Path 3: Engaging in |
|---|---|---|
| Rhythmic Awareness | Expressive | Athletic Movement |
| and Concentration | Movement Competence | Activities |
| Rhythmic | Creative Movement | Athletic |
| Opportunities 0 | Opportunities 0 | Opportunities 0 |
| Rhythmic Activities 1 | Creative Movement | Athletic |
| | Activities 1 | Opportunities 1 |
| Rhythmic Activities 2 | Creative Movement | Athletic Games 2 |
| | Activities 2 | |
| Rhythmic Activities 3 | Creative Movement | Athletic Games 3 |
| | Activities 3 | |
| Rhythmic Activities 4 | Creative Movement | Athletic Games 4 |
| | Activities 4 | |
| Rhythmic Activities 5 | Creative Movement | Athletic Games 5 |
| | Activities 5 | |
| Rhythmic Activities 6 | Creative Movement | Athletic Games 6: |
| | Activities 6 | Football |

With reference to the example table ‘Neuro-Biological Dimension—Table 4’, the activity topic “movement basics” is divided into three paths that include developmental activities, namely, for developing rhythmic awareness and concentration; developing expressive movement competence; and engaging in athletic movement activities. These developmental activities may, for example, include sliding, swinging, scrolling, bouncing, and playing sports.

FIG. 4 is a schematic illustration of how the example chart 300 may be used to demonstrate a developmental-balance level, in accordance with an embodiment of the present disclosure. The output 222, when executed on the processor 204, is configured to demonstrate the developmental-balance level on the graphical user interface, as shown in FIG. 4.

In FIG. 4, a solid curve 402 represents a mapping of a first closed developmental-balance curve rendered within a spatial arrangement of the activity topics 304 and the activity dimensions 302 of the example chart 300. The solid curve 402 represents a balanced learning curve of a first student. The first student has advanced from level number ‘0’ to level numbers ‘2’ and ‘3’ in most of the activity topics 304. This indicates that the developmental-balance level of the first student is high.

A dotted curve 404 represents a mapping of a second closed developmental-balance curve rendered within the spatial arrangement of the activity topics 304 and the activity dimensions 302 of the example chart 300. The dotted curve 404 represents an unbalanced learning curve of a second student.

The second student is lagging behind in activity topics associated with spaces 406a and 406b, as shown in FIG. 4. These activity topics correspond to given points 408a and 408b bounded by the dotted curve 404, respectively.

In FIG. 4, a distance of points 410a and 410b on the dotted curve 404 from the given point 408a is greatly varied. Likewise, a distance of points 410c and 410d on the dotted curve 404 from a given point 408b is also greatly varied. The dotted curve 404 demonstrates that levels of development of the second student at the given points 408a and 408b are four or more levels below the levels of development of the second student in many other activity dimensions and/or activity topics. This indicates that the developmental-balance level of the second student is low.

In accordance with an embodiment of the present disclosure, the system for developmental evaluation is configured to influence the second student to perform one or more developmental activities from the activity topics associated with the spaces 406a and 406b, such that these developmental activities contribute to balancing user scores across all of the activity topics and the activity dimensions.

Consequently, the second closed developmental-balance curve is expanded in the spaces 406a and 406b of the mapping when a pre-defined user score for advancing within the activity topics associated with the spaces 406a and 406b has been reached. This encourages the user to perform developmental activities from activity topics and/or activity dimensions in which he/she is lagging.

In order to balance the user scores, various scoring rules may be defined by the system. In an example, a student may be assigned an initial score when he/she starts at the level number ‘0’ initially. The initial score may, for example, be a user score of ‘0 points’ (zero) in all of the activity topics and the activity dimensions. Beneficially, user scores are stored in the database 106 and updated from time to time, for example, when the user scores change.

In an example, to start, a student may be presented with a menu of developmental activities corresponding to the level number ‘0’. When the student performs one or more developmental activities corresponding to the level number ‘0’ under a particular activity topic, point values are awarded in accordance with his/her performance in the developmental activities. The point values may be any number, such as 1, 2, 5, 1.4, and 4.3.

These point values are then assembled into a user score corresponding to the level number ‘0’ under the particular activity topic. If the user score is greater than or equal to a pre-defined user score for advancing within the particular activity topic, the student advances from the level number ‘0’ to the level number ‘1’ (i.e., a next higher level) under that particular activity topic.

For example, a scoring rule defined by the system may require that a minimum user score of ‘1 point’ is awarded in each developmental activity and a minimum user score of ‘5 points’ is awarded in the particular activity topic, to advance to a next higher level in that particular activity topic. The scoring rule ensures that the student has successfully performed at least some developmental actions in each activity topic before advancing.

Moreover, when advancing from the level number ‘1’ to the level number ‘2’, the scoring rule may take into consideration whether a substantial number of developmental activities in the level number ‘0’ were accomplished, in addition to user scores in the level number ‘1’. This ensures that the student accomplishes most of the developmental activities that were required to be performed by him/her earlier.

FIG. 4 is merely an example, which should not unduly limit the scope of the claims herein. A person skilled in the art will recognize many variations, alternatives, and modifications of embodiments of the present disclosure.

FIG. 5 is a schematic illustration of an example developmental activity, in accordance with an embodiment of the present disclosure. With reference to FIG. 5, a user 502 selects a developmental activity of swinging under the activity topic “movement” of the neuro-biological dimension. Selection may be performed using, for example, indicator 218, generator 216 or both of these. The user 502 performs the developmental activity of swinging with a swing 504, while carrying a data processing unit 506, for example, in his/her pocket.

Sensors included in the data processing unit 506 measure and collect data indicative of movements of the user 502. In some examples, the data may be measured as a function of time.

The data processing unit 506 analyzes the data to identify swing movements of the user 502, and collect information about parameters related to the swing movements. These parameters may, for example, include at least one of: an intensity of swinging, a speed of swinging, a number of repetitions, and/or a duration for which the user 502 performed the developmental activity of swinging.

Additionally, the user 502 may be prompted to report manually a duration for which the user 502 performed the developmental activity of swinging, even when the duration was automatically tracked by the data processing unit 506. For illustration purposes only, let us consider that the user 502 reports the duration to be 30 minutes, while the actual duration was 20 minutes. Accordingly, the reporting reliability factor of the user 502 is determined as following:

$$\begin{matrix}Reporting reliability factor = ( manually \text{-} reported duration ) / \\ ( automatically \text{-} reported duration ) \\ = 30 / 20 \\ = 1.5\end{matrix}$$

Subsequently, the data processing unit 506 sends the collected information and the reporting reliability factor to the server 104 via a wireless communication link 508. The collected information and the reporting reliability factor may then be stored in the database 106.

Later, when the user 502 performs a developmental activity that cannot be tracked automatically, the reporting reliability factor can be used to modify future manually-reported user performances. For illustration purposes only, let us consider that the user 502 performs a developmental activity of reading, and reports a duration for which the user 502 performed the developmental activity of reading to be 60 minutes. Accordingly, the system uses the reporting reliability factor to obtain a modified duration from the manually-reported duration as following:

$$\begin{matrix}Modified duration = ( manually \text{-} reported duration ) / \\ ( reporting reliability factor ) \\ = 60 / 1.5 \\ = 40 minutes\end{matrix}$$

The modified duration may then be used to award a point value for the developmental activity of reading. The data processing unit 506 may send the modified duration to the server 104, which may then store the modified duration in the database 106.

FIG. 5 is merely an example, which should not unduly limit the scope of the claims herein. A person skilled in the art will recognize many variations, alternatives, and modifications of embodiments of the present disclosure.

The following represent several additional example developmental activities, which may be performed by a user for evaluation by a developmental evaluation system as disclosed herein.

### Example 1

A developmental activity, which may be referred to as ‘Grading Shades of Colours’, applies to a ‘Refining Visual Senses’ path within the activity topic “sensory” of the neuro-biological dimension, and may be associated with a level number ‘3’. In this developmental activity, a user explores visual characteristics of the environment as they apply to colours.

A core objective of ‘Grading Shades of Colours’ is to develop ability to make fine distinctions among colors and shades, to define and organize color impressions, and to recognize, discriminate and seriate color shades.

Other objectives of ‘Grading Shades of Colours’ include developing visual sensitivity and accuracy; developing powers of observation; supporting development of representational ability, artistry and imagination; enhancing visual communication skills and creation of artefacts; broadening vocabulary and reading skills with words and comparative words connected to colour shade gradation qualities and impressions. Vocabulary emphasized by this activity may include one or more of: shade, light, dark, lighter than, darker than, lightest and/or darkest.

As a mobile game in a virtual environment, color tablets of multiple colors, for example, including red, orange, yellow, green, blue, purple, grey and brown, are spread and organized into a graded color-star. First, the darkest color tablets are arranged into a center circle. Next, the next-to-darkest color tablets are arranged next to corresponding darkest color tablets, outside the center circle. The user continues to seek shades of the colors from the darkest to the lightest, outwards from the center circle, and to place next to a former shade in a particular color. Visually, “wings of colors” grow outwards from the center, ending up in a star-like figure in which all shades are exposed.

As a variation, the user may begin from a center, grading the shades of one color, then grading the shades of a next color, to eventually form a spiral presenting all colors and all shades.

Additionally, vocabulary and word cards may be presented as flashing images and/or still images. The user may be required to organize these word cards in a graded order: light, lighter, lightest, and/or dark, darker, darkest. Control of errors is mediated by a software program.

Within a physical learning environment, the above actions may be performed with physical color tablets and physical vocabulary cards having shades of light, dark, lighter than, darker than, lightest and darkest. Errors are controlled visually.

As an alternative within the physical learning environment, a full set of color tablets of one color are provided graded in a line, for example, seven shades of blue color. A set of seven transparent bottles are filled with a solution of water and water-soluble blue-colored paint. More water is added to the solution until its shade matches with a corresponding shade of the color tablet. If more bottles or glasses are available, additional colors and gradations may be implemented. Colored bottles may be arranged into attractive patterns, such as circles, spirals, and other creative patterns.

### Example 2

A developmental activity, which may be referred to as ‘Obstacle Course—Dunes’, applies to a ‘Developing Body Control, Balance and Self-Regulation’ path within the activity topic “motor” of the neuro-biological dimension, and may be associated with a level number ‘1’. In this developmental activity, a child is provided an opportunity to Strenuous play.

A core objective of ‘Obstacle Course—Dunes’ is to strengthen perception of his/her body, to develop physicality and new ways to use muscles, and to provide challenges to the development of balance.

Other objectives of ‘Obstacle Course—Dunes’ include reinforcing executive function, learning skills and educational performance, and learning to tumble, roll, crawl, creep, and perform other child-directed activities in a soft dune-shaped landscape. Vocabulary emphasized by this activity may include one or more of: tumbling, rolling, crawling, and/or creeping.

As a mobile game in a virtual environment, parents and/or teachers may be directed to collect pillows, roll mats and bed covers, and place them under a large carpet to create a soft dune-shaped landscape. The child may then tumble, roll, crawl, creep and perform other child-directed activities in the soft dune-shaped landscape, while carrying a data processing unit that is operable to measure his/her performance.

Additionally, vocabulary and word cards may be presented as flashing images and/or still images, to direct parents and/or teachers to supervise the child.

Within a physical learning environment, the above activities may be performed in a specially-designed and constructed physical landscape with embedded physical equipments that are capable of measuring the performance.

### Example 3

A developmental activity, which may be referred to as ‘Wheel of Feelings’, applies to a ‘Developing Ability to Emphasize and Relate to Objects of Studied Themes’ path within the activity topic “role play and drama play” of the cultural dimension, and may be associated with a level number ‘3’. In this developmental activity, a child learns to recognize and express emotions and thoughts.

A core objective of ‘Wheel of Feelings’ is to learn to identify emotions, and to develop understanding of self and others. Other objectives of ‘Wheel of Feelings’ include sustaining development of emotional and social intelligence, and developing competences for collaboration and team work. Vocabulary emphasized by this activity may include one or more of: feeling, happy, sad, mad, scared, surprised, excited, disgusted, and/or bored.

As a mobile game in a virtual environment, a playful and engaging story is told with emotion-evoking episodes. Images of virtual puppets and/or feeling faces keep popping up, when corresponding feelings are mentioned.

Additionally, a wheel-shaped image with several sectors is presented. Beside the wheel-shaped image, feeling faces may be presented as flashing images and/or still images. Feeling faces that have already been presented earlier are exposed. When the story is repeated, the wheel-shaped image rotates slowly. When the story proceeds to an episode mentioning a feeling word, such as ‘happy’, the story pauses and the wheel-shaped image stops rotating. Next, a top sector of the wheel-shaped image shows a pulsating colour. The child is then directed to select a feeling face and move it into the pulsating-coloured sector. If the selected feeling face corresponds to the feeling mentioned in the episode, the story continues, and the wheel-shaped image starts rotating again. If the selected feeling face does not match with the feeling, the child can try again until it matches. The activity is considered to be completed when the child has put all feeling faces at correct places in the wheel-shaped image.

As a variation, the child may be presented with the wheel-shaped image and the flashing and/or still images of vocabulary and word cards. The child moves feeling faces into the wheel-shaped image, and moves word cards into corresponding feeling faces. If the word card matches the feeling face, the word card stays with the feeling face. If the word card does not match the feeling face, the child is given another chance. When all feeling faces and word cards are matched, the wheel-shaped image starts rotating. Control of error is mediated by a software program.

Within a physical learning environment, the above activities may be performed in a physical gaming system with embedded physical equipments that are capable of measuring the performance. Here, parents and/or teachers supervise the child.

### Example 4

A developmental activity, which may be referred to as ‘Geometric Shapes—2D’, applies to a ‘Developing Geometric Tools of Mind’ path within the activity topic “mathematics and science” of the cognitive dimension, and may be associated with a level number ‘3’. In this developmental activity, a child learns to comprehend geometry and explore characteristics of the environment.

A core objective of ‘Geometric Shapes—2D’ is to develop ability to make fine distinctions among two-dimensional (2D) form characteristic of the environment, to develop ability to verbally define and explain shape qualities, to sustain development of fine motor skills as preparation for writing, to sustain development of eye-hand coordination, and to develop initial comprehension of basic geometric definitions.

Other objectives of ‘Geometric Shapes—2D’ include developing powers of observation, developing visual sensitivity and accuracy, and enhancing visual communication skills; supporting development of representational ability and facilitating creation of artefacts; and broadening vocabulary and reading skills with words connected to form qualities.

Vocabulary emphasized by this activity may include one or more of: square, rectangle, circle, triangle, pentagon, ellipse, oval, trapezoid, curved triangle, and/or curved cross.

As a mobile game in a virtual environment, multiple images of 2D shapes may be presented to the child. Flashing and/or still images of vocabulary may also be presented. Quadratic frames with insets in a form of different 2D shapes are presented in contrasting colours. The child explores the 2D shapes, and traces, with a finger, contours of the 2D shapes and their corresponding openings in the frame. Next, the child selects detached shapes and moves them into their corresponding openings in the frame. Control of error is mediated by a software program.

Within a physical learning environment, the child may draw the 2D shapes with a pencil or a crayon on a piece of paper, colour the 2D shapes with vertical parallel lines, cut these shapes, and glue them on paper cards. Here, parents and/or teachers supervise the child regarding correct gripping of the pencil and holding of scissors.

As a variation, the child may be provided with a 2D stand with quadratic frames in similar colour, and different movable 2D shapes as insets with knobs, in a contrasting colour to the frames. The child is encouraged to perform the activity as described earlier.

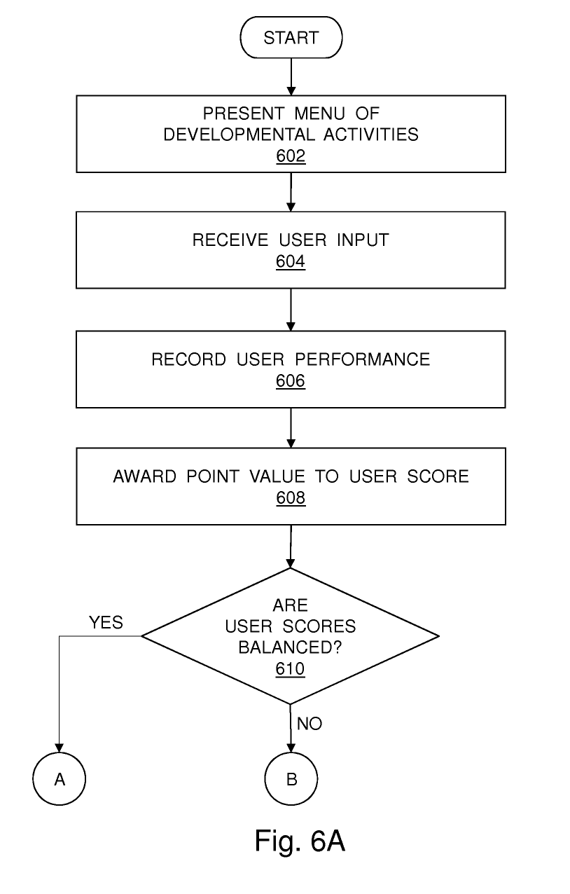

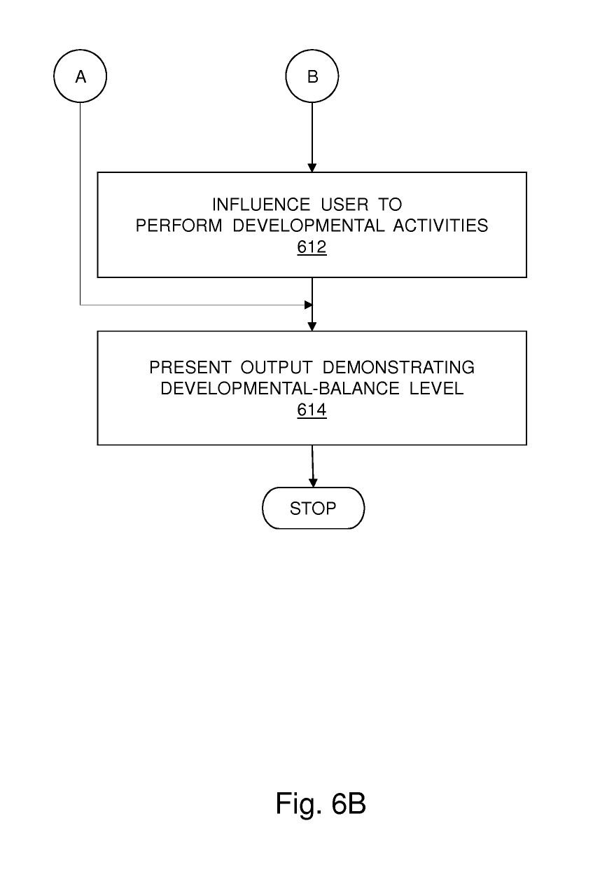

FIGS. 6A and 6B collectively are an illustration of steps of a computer-implemented method for developmental evaluation, in accordance with an embodiment of the present disclosure. The method is depicted as a collection of steps in a logical flow diagram, which represents a sequence of steps or actions that may be implemented in hardware, software, or a combination thereof.

At a step 602, a user is presented with a menu of developmental activities. Each developmental activity is associated with at least one of a plurality of activity topics and/or at least one of a plurality of activity dimensions.

At a step 604, a user input selecting a developmental activity from the menu is received.

At a step 606, a user performance of the selected developmental activity is recorded and reported. The step 606 may be performed either manually or automatically.

The method may include one or more steps during which a reporting reliability factor of the user is established by comparing a manually-reported user performance of the selected developmental activity with an automatically-reported user performance of the selected developmental activity. The reporting reliability factor of the user may then used to modify future manually-reported user performances.

Next, at a step 608, the user is awarded a point value to a user score in an activity topic and/or an activity dimension associated with the selected developmental activity.

Subsequently, at a step 610, the user score in the activity topic and/or the activity dimension is compared with user scores in other activity topics and/or activity dimensions to determine whether or not the user scores are balanced. If, at the step 610, it is found that the user scores are not balanced, a step 612 is performed. Otherwise, if it is found that the user scores are balanced, a step 614 is performed.

At the step 612, an output is used to influence the user to perform one or more developmental activities from activity topics and/or activity dimensions that contribute to balancing user scores across all activity topics and activity dimensions. In accordance with the step 612, the user is presented with developmental activities from only those activity topics and/or activity dimensions in which the user has advanced the least. This ensures that the user selects and performs developmental activities from activity topics and/or activity dimensions in which he/she is lagging.

At the step 614, the user is presented with an output demonstrating a developmental-balance level. In accordance with the step 614, a mapping of a closed developmental-balance curve is rendered within a spatial arrangement of activity topics and activity dimensions.

The steps 602 to 614 are only illustrative and other alternatives can also be provided where one or more steps are added, one or more steps are removed, or one or more steps are provided in a different sequence without departing from the scope of the claims herein.

Embodiments of the present disclosure provide a computer program product that includes a non-transitory or non-transient computer-readable storage medium storing computer-executable code for evaluating development. The code, when executed, is configured to perform the steps 602 to 614 of the method as described in conjunction with FIGS. 6A and 6B. As steps of the disclosed methods may be provided in different sequences, so the computer-executable code may be configured to provide a method having a different sequence of steps from those illustrated in FIGS. 6A and 6B. In some examples, the code may be downloaded from a software application store, for example, from an “App store”, to a data processing unit.

Embodiments of the present disclosure are susceptible to being used for various purposes, including, though not limited to, enabling users to perform developmental activities from activity topics and/or activity dimensions in which they are lagging, thereby balancing user scores across all activity topics and activity dimensions; thus, facilitating balanced overall development of the users.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method for developmental evaluation, comprising:
presenting a user with a menu of developmental activities, each developmental activity being associated with at least one of a plurality of activity topics and/or at least one of a plurality of activity dimensions;
receiving a user input selecting a developmental activity from the menu;
recording a user performance of the selected developmental activity;
awarding a point value to a user score in an activity topic and/or an activity dimension associated with the selected developmental activity in accordance with the recorded user performance;
comparing the user score in the activity topic and/or the activity dimension with user scores in other activity topics and/or activity dimensions to determine whether the user scores are balanced; and
using an output, influencing the user to perform one or more developmental activities from activity topics and/or activity dimensions that contribute to balancing user scores across all activity topics and activity dimensions.

2. The method as set forth in claim 1, further comprising presenting the user with an output demonstrating a developmental-balance level.

3. The method as set forth in claim 2, wherein presenting the user with the output further comprises rendering a mapping of a closed developmental-balance curve within a spatial arrangement of activity topics and activity dimensions.

4. The method as set forth in claim 3, wherein rendering the mapping of the closed developmental-balance curve further comprises greatly varying a distance of points on the closed developmental-balance curve from a given point bounded by the closed developmental-balance curve when the developmental-balance level is low.

5. The method as set forth in claim 2, further comprising expanding the closed developmental-balance curve in a space of the mapping when a pre-defined user score for advancing within an activity topic or an activity dimension associated with that space has been reached.

6. The method as set forth in claim 1, further comprising establishing a reporting reliability factor of the user by comparing a manually-reported user performance of the selected developmental activity with an automatically-reported user performance of the selected developmental activity.

7. The method as set forth in claim 6, further comprising using the reporting reliability factor of the user to modify future manually-reported user performances.

8. A system for developmental evaluation, comprising:
a data processing unit;
a generator executing on the data processing unit and configured to present a user with a menu of developmental activities in which each developmental activity is associated with at least one of a plurality of activity topics and/or at least one of a plurality of activity dimensions;
an indicator executing on the data processing unit and configured to receive a user input selecting a developmental activity from the menu;
a user performance output associated with selected and performed developmental activities;
an accumulator executing on the data processing unit and configured to, in accordance with the user performance output, assemble a user score from point values awarded within activity topics and activity dimensions associated with the selected and performed developmental activities;
an comparison engine executing on the data processing unit and configured to compare the user score in an activity topic and/or an activity dimension with user scores in other activity topics and/or activity dimensions to determine whether the user scores are balanced; and
a regulator executing on the data processing unit and configured to influence the user to perform one or more developmental activities from activity topics and/or activity dimensions that contribute to balancing user scores across all activity topics and activity dimensions.

9. The system as set forth in claim 8, further comprising an output executing on the data processing unit and configured to demonstrate a developmental-balance level.

10. The system as set forth in claim 9, wherein the output is further configured to render a mapping of a closed developmental-balance curve within a spatial arrangement of activity topics and activity dimensions.

11. The system as set forth in claim 10, wherein the output is further configured to greatly vary a distance of points on the closed developmental-balance curve from a given point bounded by the closed developmental-balance curve when the developmental-balance level is low.

12. The system as set forth in claim 10, wherein the output is further configured to expand the closed developmental-balance curve in a space of the mapping when a pre-defined user score for advancing within an activity topic or an activity dimension associated with that space has been reached.

13. The system as set forth in claim 8, further comprising a reporting reliability factor of the user that represents a comparison between a manually-reported user performance of a selected and performed developmental activity with an automatically-reported user performance of the selected and performed developmental activity.

14. The system as set forth in claim 13, further comprising an adjustor executing on the data processing unit and configured to modify future manually-reported user performances using the reporting reliability factor of the user.

15. A computer program product comprising a non-transitory computer-readable storage medium storing computer-executable code for evaluating development, wherein the code, when executed, is configured to:
present a user with a menu of developmental activities, each developmental activity being associated with at least one of a plurality of activity topics and/or at least one of a plurality of activity dimensions;
receive a user input selecting a developmental activity from the menu;
record a user performance of the selected developmental activity;
award a point value to a user score in an activity topic and/or an activity dimension associated with the selected developmental activity in accordance with the recorded user performance;
compare the user score in the activity topic and/or the activity dimension with user scores in other activity topics and/or activity dimensions to determine whether the user scores are balanced; and
use an output, influencing the user to perform one or more developmental activities from activity topics and/or activity dimensions that contribute to balancing user scores across all activity topics and activity dimensions.

16. The computer program product as set forth in claim 15, wherein the code, when executed, is further configured to present the user with an output demonstrating a developmental-balance level.

17. The computer program product as set forth in claim 16, wherein presenting the user with the output further comprises rendering a mapping of a closed developmental-balance curve within a spatial arrangement of activity topics and activity dimensions.

18. The computer program product as set forth in claim 17, wherein rendering the mapping of the closed developmental-balance curve further comprises greatly varying a distance of points on the closed developmental-balance curve from a given point bounded by the closed developmental-balance curve when the developmental-balance level is low.

19. The computer program product as set forth in claim 15, wherein the code, when executed, is further configured to establish a reporting reliability factor of the user by comparing a manually-reported user performance of the selected developmental activity with an automatically-reported user performance of the selected developmental activity.

20. The computer program product as set forth in claim 19, wherein the code, when executed, is further configured to use the reporting reliability factor of the user to modify future manually-reported user performances.
